(19) United States
(12) Patent Application Publication
(10) Pub. No.: US 2011/0257006 A1
(43) Pub. Date: Oct. 20, 2011

(54) METHOD FOR PREPARING A STRUCTURED POROUS MATERIAL COMPRISING NANOPARTICLES OF METAL 0 IMBEDDED IN THE WALLS THEREOF

(75) Inventors: Chloe Thieuleux, Villeurbanne (FR); Malika Boualleg, Villeurbanne (FR); Jean-Pierre Candy, Caluire (FR); Laurent Veyre, Jardin (FR); Jean-Marie Basset, Caluire Et Cuire (FR)

(73) Assignee: UNIVERSITE CLAUDE BERNARD LYON I, VILLEURBANNE CEDEX (FR)

(21) Appl. No.: 13/122,420

(22) PCT Filed: Sep. 24, 2009
(86) PCT No.: PCT/FR2009/051809

§ 371 Date: Jul. 5, 2011

(30) Foreign Application Priority Data
Oct. 7, 2008 (FR) 0856803

(51) Int. Cl. B01J 35/10; B01J 21/08; B82Y 30/00

(52) U.S. Cl. 502/239; 502/262; 502/261; 502/242; 502/237; 977/902

(57) ABSTRACT

The present invention relates to a process for producing a structured porous material comprising a structured inorganic framework made up of metal-oxide based walls in which nanoparticles of metal 0 are incorporated, which comprises the following steps:
a) formation of a suspension of hydrophilic nanoparticles of metal 0 stabilized by non-exchangeable ligands that give the nanoparticles their hydrophilic character;
b) growth of the inorganic framework from an inorganic precursor around the nanoparticles of metal 0 stabilized by the non-exchangeable hydrophilic ligands, in the presence of a pore-forming agent; and
c) elimination of the pore-forming agent and at least partially of the non-exchangeable ligands that give the nanoparticles their hydrophilic character.

The present invention relates to the technical field of structured porous materials, especially those used in the catalysis field.

There are many applications for structured porous materials, especially as absorbents, catalysts, catalyst supports and, more recently, in the separation, medical diagnostic or microelectronics fields.

Many structured porous materials are known. To give an example, the following may in particular be mentioned:
non-crystalline mesoporous/microporous oxide or mixed oxide materials of structured porosity, such as those of the M41S family (these being mesoporous molecular sieves, especially those described in “A new family of mesoporous molecular sieves prepared with liquid crystal templates.”, Beck, J. S.; Vartuli, J. C.; Roth, W. J.; Leonowicz, M. E.; Kresge, C. T.; Schmitt, K. D.; Chu, C. T. W.; Olson, D. H.; Sheppard, E. W.; McCullen, S. B.; Higgins, J. B.; and Schlenkert, J. L.; J. Am. Chem. Soc (1992), 114(27), 10834-43) including MCMs (standing for Mobil Corporation Materials), and the HMS (Hexagonal Mesoporous Silica), MSU (Michigan State University) and SBA (Santa Barbara) family;
structured macroporous materials; and
structured bimodal materials having two types of porosity, especially the microporous/mesoporous or mesoporous/macroporous type.

Some of these materials are used as heterogeneous catalysts which usually are based on or consist of a metal oxide, a metalloid oxide, mixed metal, metalloid or metal/metalloid oxide or a mixture of said oxides, within which metal particles, in particular particles of metal 0, such as platinum, ruthenium, nickel, gold or silver, are incorporated. As an example of such catalysts, mention may be made of platinum-containing catalysts supported on MCM-41, on mesoporous or microporous matrices or on zeolites for various catalytic reactions such as the reduction of nitrogen oxides NOx, the combustion of light (C2 to C4) alkanes, hydroisomerization, etc. (see the references: “Platinum catalysts supported on macrostructured MCM-41 for the selective catalytic reduction of lean NOx with hydrocarbons” Park, J.-I.; Yun, J.-S.; Jeong, K.-E.; and Ihm, S.-K., Studies in Surface Science and Catalysis, 170B, 1362-1367 (2007); “Surface properties of platinum catalysts based on various nanoporous matrices” Sobczak, Izabela; Grams, Jacek; and Ziolek, Maria; Microporous and Mesoporous Materials, 99(3), 345-354 (2007); “The origin of the enhanced activity of Pt/zeolites for combustion of C2-C4 alkanes” Garetto, T. F.; Rincon, E.; and Apesteguia, C. R., Applied Catalysis, B: Environmental, 73 (1-2), 65-72 (2007); “Hydroisomerization of a refinery naphtha stream over platinum zeolite-based catalysts” Ramos, Maria Jesus; Gomez, Juan Pedro; Dorado, Fernando; Sanchez, Paula; and Valverde, Jose Luis, Chemical Engineering Journal, 126 (1), 13-21 (2007); “Development of a simple method for the preparation of novel egg-shell type Pt catalysts using hollow silica nanostructures as supporting precursors” Wang, Jie-Xin; and Chen, Jian-Feng, Materials Research Bulletin, 43 (4), 889-896 (2008); “Toward a molecular understanding of shape selectivity” Smit, Berent and Maesen Theo L. M., Nature, 451, 671-678 (2008)).

The mesoporous structured materials such as M41S are, in particular, obtained by what is called the LCT (Liquid Crystal Templating) process which consists in forming a mineral matrix such as a silica or aluminosilicate gel in the presence of amphiphilic compounds of the surfactant type. This process employs what is conventionally called a sol-gel process. Schematically, the structure of the gel initially adopted by the surfactant molecules impresses its final shape on the mineral matrix. It would seem that, within the gel, the mineral precursors are located on the hydrophilic parts of the amphiphilic compounds before condensing therebetween, thereby conferring in fine on the mineral matrix obtained a spatial arrangement imprinted on that of the liquid crystal. By eliminating the surfactant, especially by a heat treatment, a mesoporous structured material having a structure determined by the impression of the initial liquid crystal structure is obtained (C. T. Kresge, et al., Nature 1992, 359, 710-712 and D. Zhao, et al., Science 1998, 279, 548).

Many studies are based on the incorporation of metal particles into oxide-based porous structures, in particular on techniques employing in situ metal ion and reduction reactions of the metal (a. Goguet, A. et al., J. Catal. 2003, 220, 280-290; b. Chytil, S. et al, Topics in Catalysis 2007, 45, 93-99) or else vapor deposition of metal compounds followed by their decomposition (Benesis, A. H. et al., J. Catal. 1968, 10, 328) or else impregnation techniques (Konya, Z. et al. Catal. Lett. 2007, 113, 19-28).

Admittedly, these techniques do allow particles of different metals to be incorporated into porous supports, but they do not prove satisfactory in terms of controlling the size of the particles or controlling the distribution of the metal particles within the material. This lack of control results in particular in premature sintering of the particles during the heat treatment or else, in the context of catalytic applications, a reduction in the activity of the catalyst.

Other studies (Yang, C. M.; Lin, H. A.; and Zibrowius, B. et al., Chem. Mater. 19, 2007, 13, 3205) deal with the selective decomposition of palladium salts in the micropores of microporous and mesoporous materials as the result of prior grafting of organic ligands in the microporosity. This is made possible by carrying out surface treatments of the mesopores, as far as possible to prevent grafting in the mesopores. This method enables nanoparticles to be generated in a preexisting support. In addition, the particles are about the size of the micropores of the material, i.e. they have a size of less than 2 nm.

Other prior studies have described processes for integrating metal aggregates or particles into a material, but in these cases, the particles are either integrated into the pores of the inorganic material obtained or the inorganic material obtained is not organized.

For example, document CA 2 499 782 describes a process for producing a porous silicate material by condensation of a silicate that functions as a precursor in the presence of a ligand for a metal. In that document, the functionalized silicate material is obtained prior to the addition of metal particles. Example 6 of document CA 2 499 782, however, provides for a material to be grown around nanoparticles stabilized with MPTMS, which is a ligand that comprises a thiol functional group. However, the palladium particles used in this process are large aggregates of nonuniform size. Owing to the size of the particles involved, they cannot be positioned in the walls of the inorganic material obtained.

As regards document FR 2 901 715, this describes a process for producing a hybrid nano-material containing optionally oxidized metal nanoparticles, which comprises:
1) the formation of nanoparticles of said metal, from a precursor of said metal, in the presence of a ligand of formula (L):

Y-X-G (L)

under a hydrogen pressure;
2) polymerization of the ligand (L) within a solid material; and
3) calcination of the material obtained. The above document states that the part G represents a hydrolyzable group. The ligands used in the examples are exchangeable ligands. In addition, in the above document, the material obtained is nonstructured, given that there is no provision to use a pore-forming agent. Moreover, the amount of inorganic material is very low compared with the metal particles, see example 1 of document FR 2 901 715 in particular.

Aprile Carmela et at., in J. Mater. Chem., 2005, 15, 4408-4413, describe a process that involves stabilized gold nanoparticles in the presence of a hydrophilic ligand of the cetyltrimethylammoniumtrialkoxysilane (CTA⁺) type and the material is synthesized by contacting TEOS with silylated organic precursors and hexadecyltrimethylammonium bromide as structuring agent. Silane-type ligands are therefore used, but the (alkoxy)silane part is not located on the nanoparticles side and therefore does not make it possible to have a non-exchangeable ligand. Moreover, on page 4411, it is indicated that the metal nanoparticles are located in the pores of the material obtained. Mention may also be made of the publication by Gerolamo Budroni et al. in Journal of Catalysis 2007, 251, 345-353 which describes a similar process in which no pore-forming agent is used, so that the material obtained is not structured.

Patent application WO 01/32558 proposes materials incorporating particles within the walls of mesoporous structures. However, only particles of oxides, hydroxides or oxyhydroxides of metals that are very difficult or even impossible to reduce to metal 0 are incorporated into the materials. The purpose of these particles incorporated into inorganic matrices is to improve the crystallinity thereof and to confer different physico-chemical properties (adsorption, mechanical strength, oxidation-reduction, especially for photocatalysis and catalysis, etc.) thereon, but in no case do they make it possible to carry out catalytic functions, as particles of metal 0 do, such as selective hydrogenation reactions (hydrogenating alkynes to alkenes and alkenes to alkanes, etc.), hydrocarbon dehydrogenation reactions, hydrocarbon hydrogenolysis, Fischer-Tropsch reactions or hydrodechlorination reactions (dechlorinating chlorobenzene to benzene), etc.

In addition, the major problem in heterogeneous catalysis is deactivation of the catalysts. This loss of activity, due to catalyst poisoning, for example, by carbon residues, over the course of time requires a high-temperature treatment, for example in a stream of an oxidizing gas, in order to regenerate the catalyst. However, this treatment very often results in the particles contained in the solid being sintered. This sintering problem has, at the present time, only been partly solved. To avoid it as far as possible, dopants are added in order to stabilize said particles, but these are, consequently, much less active during the desired catalytic reaction.

In this context, one of the objectives of the invention is to provide a novel process for producing structured porous materials for the customized localization of one or more types of metal particle in a structured porous inorganic framework, this process having to be easy to implement.

Another objective of the invention is to provide a process resulting in structured porous materials incorporating metal particles which are particularly stable and in which the metal particles are reactive and accessible because of their regular distribution and their location.

Thus, one subject of the present invention is a process for producing a structured porous material comprising a structured inorganic framework made up of metal-oxide-based walls in which particles of metal 0 are incorporated, which comprises the following steps:
formation of a suspension of hydrophilic particles of metal 0 stabilized by non-exchangeable ligands that give the particles their hydrophilic character;
growth of the inorganic framework from an inorganic precursor around the particles of metal 0 stabilized by the non-exchangeable ligands that give the particles their hydrophilic character, in the presence of a pore-forming agent; and
elimination of the pore-forming agent and at least partially of the non-exchangeable ligands that give the particles their hydrophilic character.

The materials that can be obtained by such a process also form an integral part of the invention.

The description below, with reference to the appended figures, will enable the invention to be better understood.

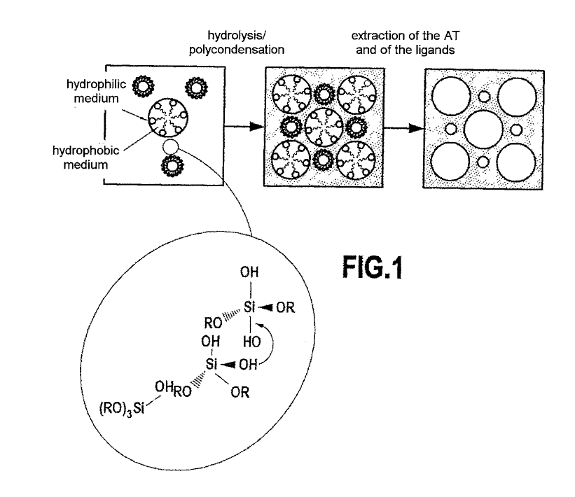

FIG. 1 shows schematically the successive steps of the process according to the invention.

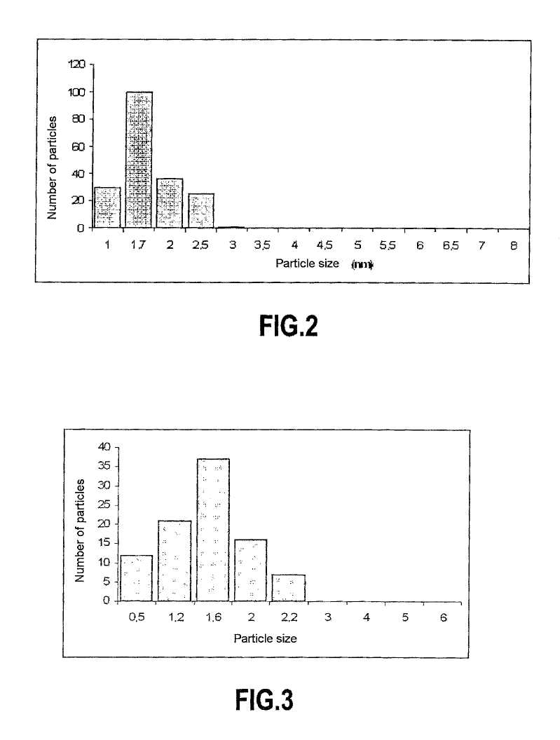

FIGS. 2, 3 and 4 represent histograms of the size of the particles obtained.

FIG. 5 shows the small-angle X-ray powder diffractogram of a material obtained according to the process of the invention.

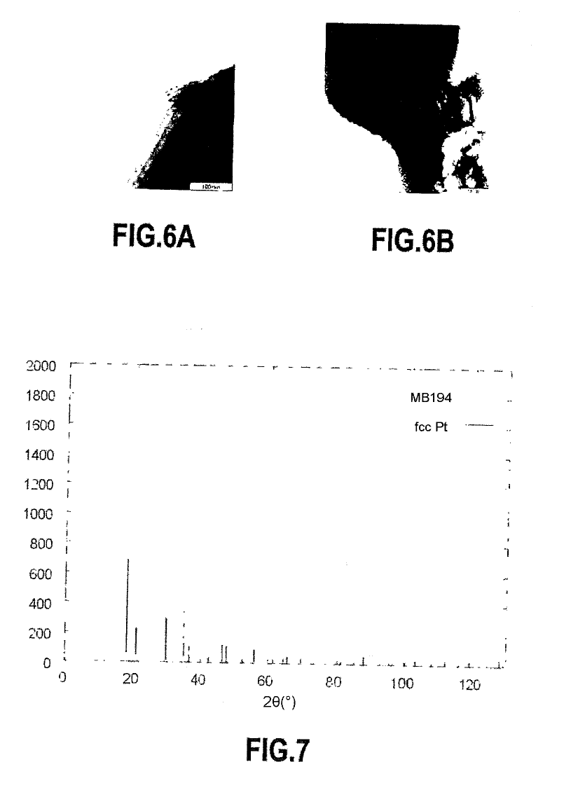

FIGS. 6A and 6B are transmission electron microscope images of a material obtained according to the process of the invention.

FIG. 7 shows the WAXS spectrum of a material obtained according to the process of the invention.

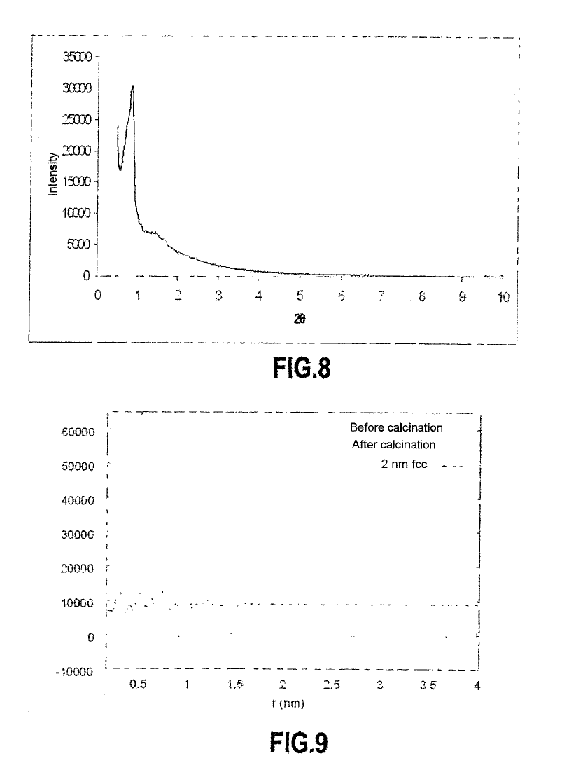

FIG. 8 shows the small-angle X-ray powder diffractogram of a material obtained according to the process of the invention.

FIG. 9 shows in bold the experimental Fourier transforms before and after calcination of a material obtained according to the process of the invention and the theoretical models of a 2 nm Pt crystallite in a crystallographic lattice of the face centered cubic (fcc) type.

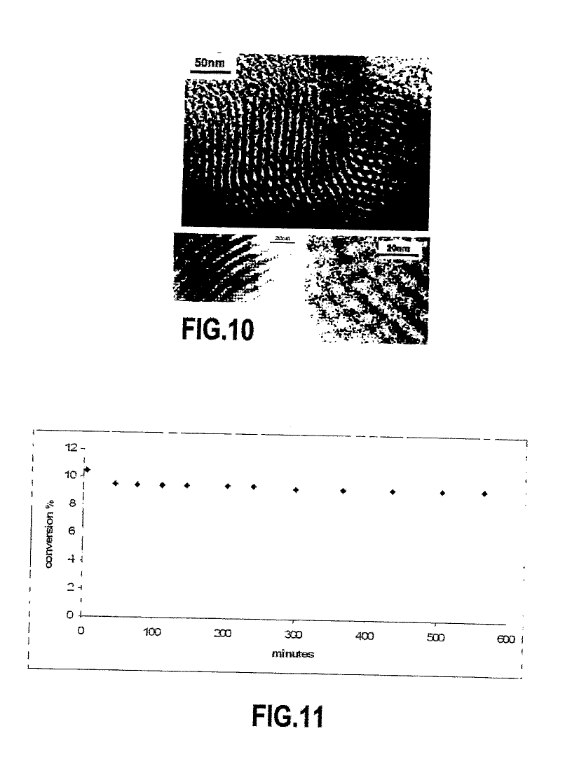

FIG. 10 shows various transmission electron microscope images of a material obtained according to the process of the invention.

FIG. 11 shows the degree of conversion of propene to propane as a function of time for a material obtained according to the process of the invention.

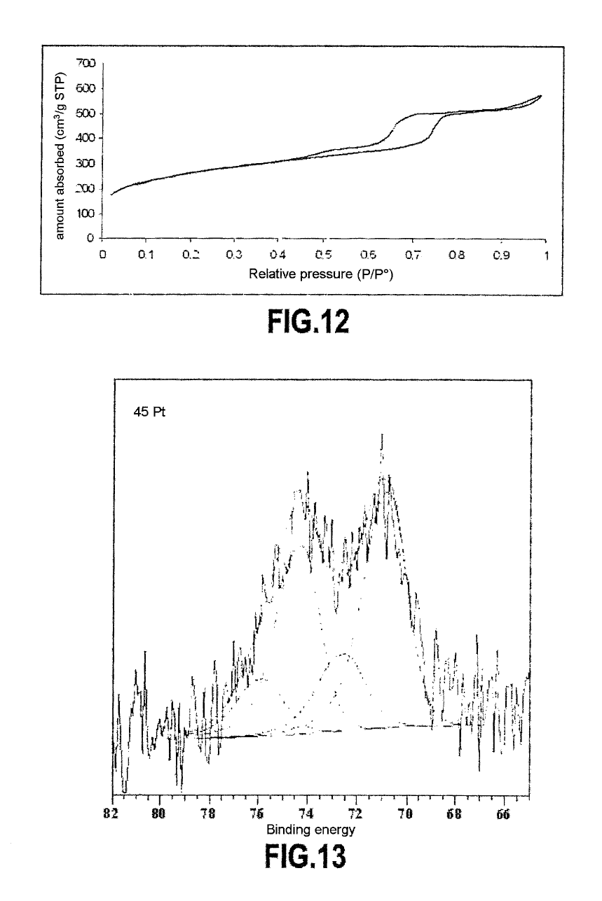

FIG. 12 shows the nitrogen adsorption/desorption isotherm at −196° C. (77 K) of a material obtained according to the process of the invention.

FIG. 13 shows the XPS spectrum of a material obtained according to the process of the invention.

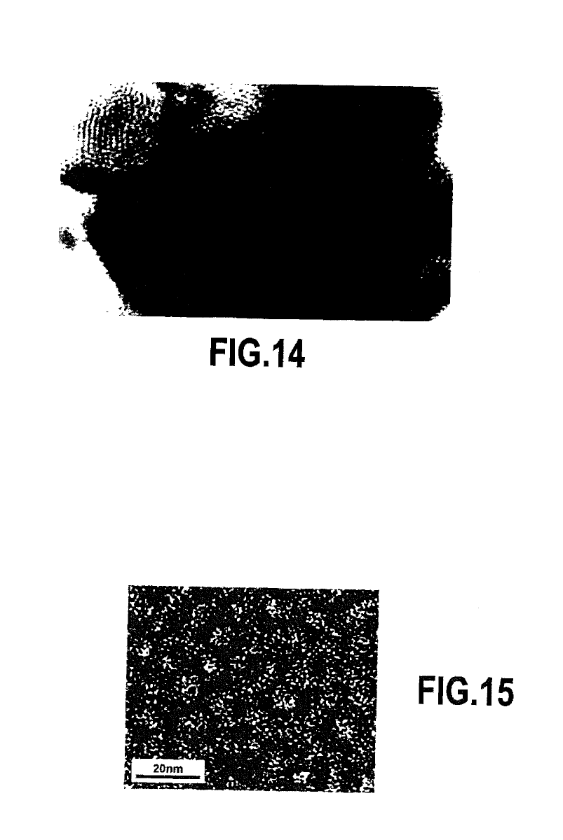

FIG. 14 shows a transmission electron microscope image of a material obtained according to the process of the invention.

FIG. 15 shows a transmission electron microscope image of a material obtained according to the process of the invention.

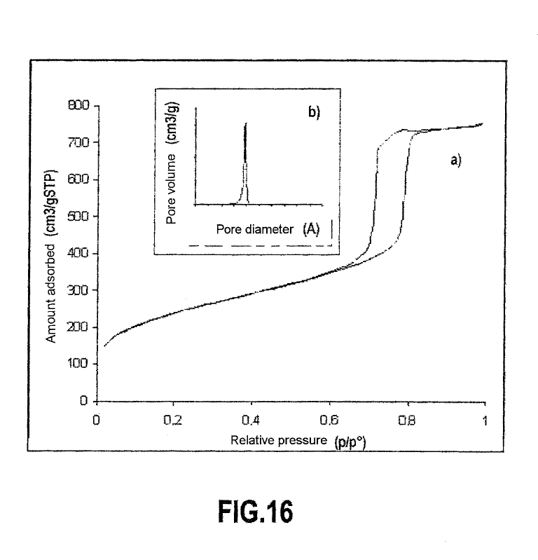

FIGS. 16a) and b) show the nitrogen adsorption/desorption isotherm at −196° C. (77 K) and the pore distribution, respectively, of a material obtained according to the process of the invention.

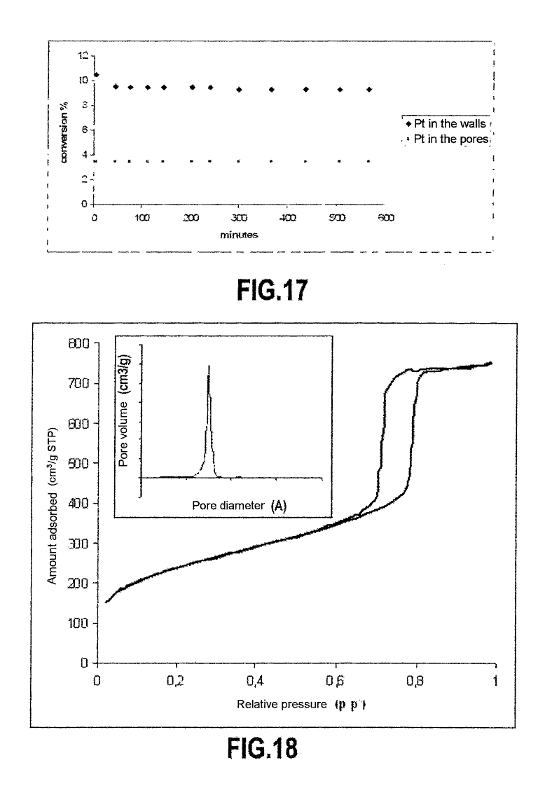

FIG. 17 compares the degrees of conversion obtained by hydrogenation of propene in a dynamic reactor with a material according to the invention, and a material with Pt particles in the pores.

FIG. 18 shows the nitrogen adsorption/desorption isotherm at −196° C. (77 K) of a material obtained according to the process of the invention.

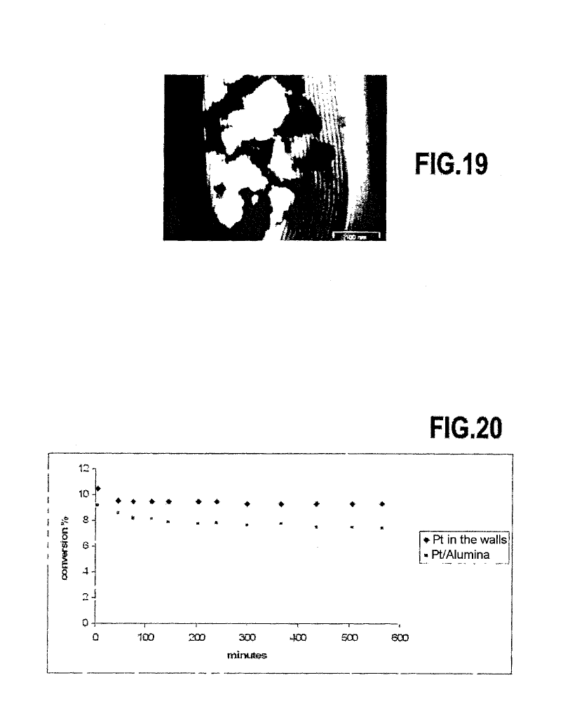

FIG. 19 shows a transmission electron microscope image of a material obtained according to the process of the invention.

FIG. 20 compares the degrees of conversion obtained for the hydrogenation of propene using a reference catalyst and a material according to the invention.

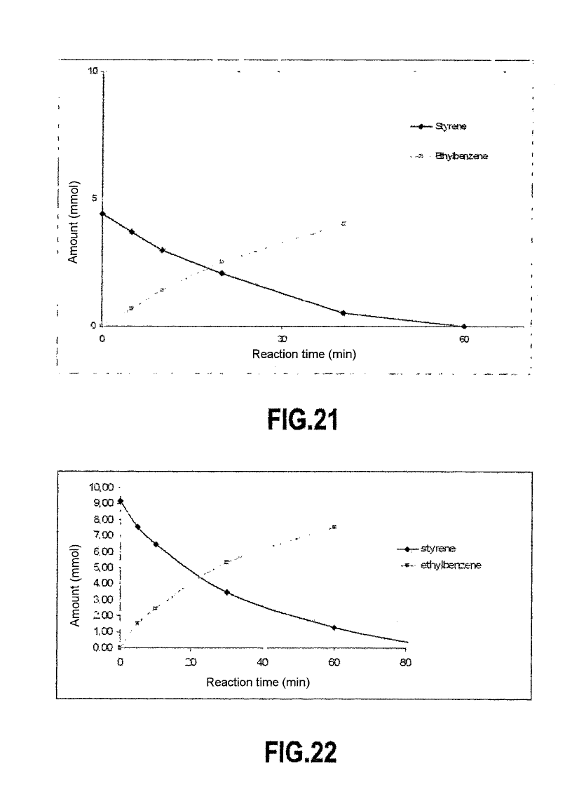

FIG. 21 shows the amounts of styrene and ethylbenzene as a function of time, obtained during hydrogenation of styrene with a material according to the invention.

FIG. 22 shows the amounts of styrene and ethylbenzene as a function of time, during the hydrogenation of styrene with a Pt reference catalyst on alumina.

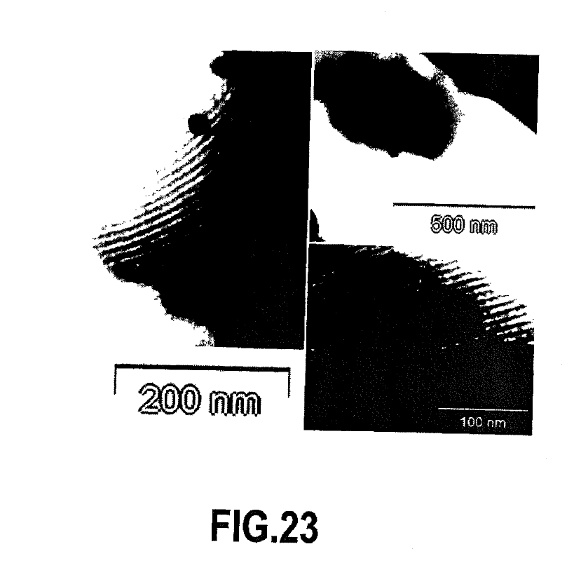

FIG. 23 shows, for comparison, a transmission electron microscope image of a material containing hydrophilic Pt particles initially stabilized by an exchangeable hydrophilic ligand of the diol type.

In the context of the process according to the invention, the inorganic framework of the structured porous material is grown directly around existing metal particles. What is thus obtained is a regular distribution of the metal particles that are well spaced and distributed within the material obtained. The process according to the invention makes it possible to prevent agglomeration of the metal particles and thus leads to good structuration of the material, compared with the prior techniques. Also, within the material obtained, the particles are small in size and well distributed. The particles present within the material have a nanoscale size, that is to say, in particular, that the metal core (excluding ligands) is spherical and that at least, for 50% of the nanoparticles population, the metal core has a mean diameter of 1 to 10 nm, the mean diameter being determined, for example by transmission electron microscopy in the form of a size histogram or, preferably, by the WAXS (wide-angle X-ray scattering) technique. The material obtained is particularly stable, even when it undergoes a heat treatment, the pore size and the metal particles remaining unchanged after treatment.

Thanks to the process according to the invention, the particles are uniformly distributed, thereby limiting their sintering, and are stabilized by the inert porous framework, thereby also limiting their sintering, while still leaving them perfectly accessible and reactive.

The process according to the invention results in a porous structured material. The expression “structured material” is understood to mean a material that has an organized structure, in particular characterized by the presence of at least one diffraction peak in a small-angle X-ray powder diffractogram (Glatter and Kratky, Academic Press, London, (1982)). The diffraction peak observed in the small-angle X-ray powder diffractogram obtained for a structured material is associated with a characteristic repeat distance of the material in question. This repeat distance is also called the “spatial repeat period of the structured system” and corresponds, in the case of a porous material, to the periodicity of the pores within the material. In the material according to the invention, the framework is therefore structured, which is why we may speak of walls and pores.

The material obtained by the process according to the invention is porous, the pore size being a function of the pore-forming agent used. In particular, the material obtained is microporous, mesoporous or exhibits combined microporosity/mesoporosity. A microporous material is understood to mean one having pores smaller in size than 2 nm and a mesoporous material is understood to mean one having pores with a size between 2 and 50 nm. The texture of a material (namely the specific surface area, the type of pore, the pore size and the pore volume) is obtained by nitrogen adsorption/desorption at −196° C. (77 K).

The inorganic framework of the material obtained in the context of the invention consists of a metal oxide. The term “metal oxide” is used broadly in the context of the invention and includes in particular metal oxides, metalloid oxides, and mixed metal and/or metalloid oxides.

As examples of structured porous materials according to the invention, mention may be made of porous structures made of at least one oxide of a metal of groups 3 to 11, or of at least one oxide of a metalloid of groups 2 and 12 to 14, or of a mixed oxide of various metals or metalloids or of a mixture of these oxides. In particular, mention may be made of silicon, aluminum, titanium, tin, tantalum and zirconium oxides. Frameworks made of silica or mixed oxides, silica/titanium oxide or silica/alumina (also called aluminosilicates), are particularly preferred.

The structuration of the final material may be of the vermicular, lamellar, hexagonal (1D or 2D) or cubic type, with a preference for hexagonal structuration.

Preferably, the material obtained has a specific surface area of 20 to 1200 m²/g and preferentially 300 to 1100 m²/g in the case of a framework made up predominantly of silica. The specific surface area is especially determined by measuring the nitrogen adsorption/desorption according to the method described below in the characterization methods.

The framework is produced, in the presence of at least one pore-forming agent, especially of the surfactant type, in situ around hydrophilic metal particles owing to the presence of non-exchangeable ligands chosen both for giving them their hydrophilic character and for stabilizing them. The non-exchangeable nature of the ligands, added to the fact that they make the particles hydrophilic, makes it possible for the particles to be localized, in the final material, in the walls and not in the pores of the porous structure. It is important for the ligands to be non-exchangeable so that the metal particles retain their hydrophilic character. The term “non-exchangeable” is understood in particular to mean that the ligands giving the particles a hydrophilic character must not be exchanged with the pore-forming agents. This is because such an exchange with surfactants acting as pore-forming agents would have the effect of making the metal particles hydrophobic, and these would then be placed in the pores of the material and not in the walls of the framework.

The ligands used give the particles a hydrophilic character owing to the presence of polar or polarizable groups. These ligands therefore have a hydrophilic character when they are on the particle and are called hydrophilic ligands in the rest of the description. The term “polar group” is understood to mean a group that has a dipole moment. The term “polarizable group” is understood to mean a group that polarizes (i.e. that has a dipole moment) under specific conditions (as, for example, in a solvent with a high dielectric constant). As examples of polar or polarizable groups, mention may be made in particular of halogen atoms such as chlorine, or amine, ammonium, phosphonate, phosphonium, hydroxide, thiol, sulfonate, nitrate, carbonate, and alcohol groups, etc. As particularly suitable amine groups mention may be made of imidazoles, imidazolium salts and alkyltrimethylammonium salts.

The non-exchangeable character of the ligand may especially be provided by the presence of a silicon, tin or germanium atom, acting as the point where the ligand is anchored onto the metal particle. Ligands of the silane type or stannous (or stannic) derivatives are also preferred because they are easier to synthesize. The ligands used in the context of the invention have various advantages over the ligands used in the prior art, which comprise a thiol functional group that may lead to a stable bond with certain particles. This is because thiol ligands are not compatible with many catalytic reactions, for which they behave as poisons. In contrast, unexpectedly, the ligands used in the context of the invention are completely compatible with the use of the materials obtained in catalysis. In particular, it has been found that a material obtained by the process according to the invention that contains Pt nanoparticles (as demonstrated in the examples below) is active in the hydrogenation of propene: the metal nanoparticles of the material are therefore accessible and reactive. In addition, the calculated. TOF of a reference catalyst containing “bare” platinum nanoparticles (i.e. with no surface ligands) is very similar to that of the material according to the invention: the Pt nanoparticles contained in the walls of our material are therefore as accessible and reactive as “bare” Pt particles. The Pt nanoparticles are therefore not poisoned by the presence of Si atoms on their surface.

As an example of non-exchangeable hydrophilic ligands giving the particles their hydrophilic character that may be employed in the context of the invention, mention may be made of 3-chloropropylsilane, N-(3-silylpropyl)imidazole, chlorobenzylsilane, chlorodimethylsilane, N-(3-silylpropyl)alkylimidazolium salts or N-(3-silylpropyl)arylimidazolium salts, N-(benzylsilyl)imidazole, N-(benzylsilyl)alkylimidazolium salts or N-(benzylsilyl)arylimidazolium salts, and also N-(benzylsilyl)trialkylammonium salts or dibutyl-4,7,10-trioxaundecylstannane and the like. Such ligands are commercially available or may be produced using techniques well known to those skilled in the art. In the case of ligands comprising a tin or germanium atom, the reader may refer to F. Ferkous, Journal of Organometallic Chemistry, 1991, Volume 420, Issue 3, Pages 315-320 and to P. Riviere, Journal of Organometallic Chemistry, 49 (1973) 173-189.

The successive steps of the process according to the invention are shown in FIG. 1. The first step of the process according to the invention consists in forming a colloidal suspension of hydrophilic metal particles stabilized by non-exchangeable ligands. Such suspensions are produced using techniques well known to those skilled in the art.

In particular, a metal precursor, conventionally used in synthesizing particles of the desired metal, is brought into contact with the non-exchangeable hydrophilic ligands comprising a polar or polarizable group in a conventional polar organic solvent (water, alcohol, THF, ether, etc.) or apolar organic solvent (saturated or unsaturated hydrocarbons), THF being particularly preferred. The synthesis of the metal particles is preferably carried out under the pressure of hydrogen or in the presence of a reducing agent (such as NaBH₄) advantageously with 0.2 to 5 equivalents of stabilizing ligands per atom of metal involved. As an example of metal precursors, mention may be made of Ru(COD)(COT), Pt(dba)₂, Ni(COD)₂, HAuCl₄, etc. where dba=dibenzylidene acetone, COD=cyclooctadiene and COT=cyclooctatriene.

The metal particles may in particular be platinum, ruthenium, gold, nickel, cobalt, iron, silver, palladium or rhodium particles.

The particles obtained and used in the context of the invention are of nanoscale size, i.e. the metal core (excluding ligands) is preferably spherical and at least, for 50% of the nanoparticle population, the metal core has a mean diameter of 1 to 10 nm, the mean diameter being determined, for example, by transmission electron microscopy in the form of a size histogram or preferably, by the WAXS technique. The metal particles are advantageously monodispersed, that is to say they have a very narrow size distribution around a mean value and in particular 50% of the particles have a size corresponding to the mean size ±0.5 nm, determined by transmission electron microscopy in the form of a size histogram. The size of the suspended particles corresponds to the size of the particles present in the material obtained, the process according to the invention causing no variation in size.

The second step consists in growing the porous structure of the material around the suspended metal particles in a suitable solvent, in the presence of a pore-forming agent, in order to confer the desired porosity. The metal particles are localized within the actual structure constituting the framework of the material and not inside the pores. The metal particles are therefore completely trapped physically in the walls of the framework of the material.

The mineral precursor used is, for example, a metal or metalloid alkoxide or hydroxide, among which titanium or aluminum silicates, tetraalkoxysilanes and tetraalkoxides are preferred. Conventionally, the metal framework is grown by a sol-gel process (L. L. Hench et at. Chem. Rev. 1990, 33-72 and S. Biz et al. Catal. Rev.—Sci. Eng 1998, 0 (3). 329-407).

In particular, the metal framework is grown in an aqueous medium or an aqueous medium mixed with at least one cosolvent of the alcohol type (preferably linear alcohols: butanol etc.), or of the ether type (preferably THF) or dimethylformamide (DMF).

Preferably, the framework is grown under at least one of the following conditions, either individually or preferably in combination:
a temperature from 0° C. to 100° C., preferably 20° C. to 65° C.,
a (metal of the inorganic precursor/pore-forming agent) molar ratio of 30-300;
a (metal of the particles/metal of the inorganic precursor) weight ratio of 0.001 to 50% or else less than 10%, and preferably from 0.001 to 5% and preferentially from 0.005 to 5%, or even from 0.05 to 5%,
a pH of 0 to 10 and preferably 0 to 4,
in the presence of a hydrolysis-polycondensation catalyst of the acid, base or nucleophilic type and preferably such as HCl (acid type), NH₃, KOH, or NaOH (base type) or NaF or TBAF (nucleophilic type).

It is also possible to produce, before the addition of the inorganic precursor necessary for growing the framework, a colloidal suspension of particles of metal 0 stabilized and rendered hydrophilic by non-exchangeable ligands, to which the pore-forming agent is added, preferably in a water/THF mixture. To do this, the pore-forming agent will be added to the previously formed colloidal suspension of metal particles, or vice versa.

The porous material is grown around the metal oxide particles in the presence of a pore-forming agent, also known as a template or surfactant. Usually the interactions between the surfactant and the mineral precursors will be electrostatic or Van der Waals interactions. The pore-forming agent present in the reaction mixture is an amphiphilic surfactant compound, especially a copolymer. The essential characteristic of this compound is that it can form micelles in the reaction mixture so as to lead, through the cooperative texturing mechanism defined above, to the subsequent formation of a mineral matrix having an organized structure. As examples of such organic molecules that can be used as pore-forming agents, the following may especially be mentioned:
anionic templates, such as sodium dodecyl sulfate;
cationic templates such as ammonium salts and especially tetraalkylammonium salts such as cetyltrialkylammonium or dodecyltrialkylammonium salts, imidazolium salts, such as 1-hexadecane-3-methylimidazolium bromide, and pyridinium salts such as n-hexadecyl-pyridinium chloride;
nonionic templates and especially amines, such as hexadecylamine or dodecylamine;
alkyl polyethylene or alkylaryl polyethylene oxides, such as Brij® 52 (C₁₆H₃₃O (CH₂CH₂O)₂H), Tergitol® 15-S-12 (C₁₁₋₁₅H₂₃₋₃₁O(CH₂CH₂O)₁₂H), Triton X® 25-100 (C₁₄H₂₂O(C₂H₄O)ₙ₁ where n₁=9-10), Montanox® 20 (sorbitan-20 EO monooleyl ester), octylphenol-10 EO (p-C₈H₁₇C₆H₄O(CH₂CH₂O)₁₀H), lauryl ether-n EO (C₁₂H₂₅O (CH₂CH₂O)ₙ₂H, where n₂˜2, 4 or 8);
polysorbate templates, such as Tween® 20 (IUPAC name: polyoxyethylene (20) sorbitan monolaurate) and Tween 30;
amphiphilic-block copolymers, such as Pluronic® P123 (EO₂₀-PO₇₀-EO₂₀), Pluronic® F127 (EO₇₇-PO₂₉-EO₇₇) or Pluronic® F108 (EO₁₃₂-PO₅₀-EO₁₃₂) triblock copolymers; and
functional or nonfunctional polymers and especially block polymers such as Pluronic® P123, Pluronic® F127 or F108 mentioned above, or else conventional polymers of the PE, PP, PMMA and polystyrene type.

Such pore-forming agents have already been widely used in the prior art. In the context of the invention, it will be preferable to choose experimental conditions (nature and size of the pore-forming agent, pH of the synthesis, pore-forming agent/mineral precursor ratio, temperature, type of hydrolysis/polycondensation catalyst) so as to obtain walls of sufficient size, i.e. of sufficient thickness, to be able to insert the desired metal particles thereinto. Specifically, the various trials carried out by the inventors have shown that, in order for the metal particles to be suitably housed within the walls of the material, it is essential for the size of the particles rendered hydrophilic and stabilized by the non-exchangeable ligands to be less than or equal to the thickness of the walls. Thus, the particles may be completely integrated into the walls of the framework. The size of the particles stabilized by the non-exchangeable ligands is determined from the mean size of the particles, given by transmission electron microscopy in the form of a size histogram or, preferably, by the WAXS technique, and by modeling the space occupied by the ligands using the lengths of the bonds and the angles between the atoms. Advantageously, the process conditions will also be chosen for this purpose and will correspond to the abovementioned conditions that allow such a result to be achieved.

The thickness of the walls is, advantageously, greater than 3 nm and preferably in the range from 5 to 15 nm. The thickness of the walls is especially determined using small-angle X-ray diffraction and nitrogen adsorption/desorption measurements using the methods described below in the characterization methods.

In certain cases, it may be desirable to grow the inorganic framework around a colloidal solution of a mixture of metal particles differing in nature:
for example a mixture of metal particles of a given metal that are rendered hydrophilic and stabilized by the presence of non-exchangeable ligands, ensuring hydrophilicity thereof, and of metal particles of another metal, which are rendered hydrophilic and also stabilized by non-exchangeable ligands ensuring the hydrophilicity thereof. In this case, the material will comprise various types of metal particles in the walls;
for example a mixture of metal particles of a given metal that are rendered hydrophilic and stabilized by the presence of non-exchangeable ligands, ensuring the hydrophilicity thereof, and of hydrophobic metal particles of another metal, which are stabilized by hydrophobic ligands. In this case, the hydrophilic particles will be positioned in the walls and the hydrophobic particles in the pores.

If it is desired also to have hydrophobic particles in the pores, the pore-forming agent will advantageously be chosen so as to result in pore sizes that are large enough to accommodate at least one type of metal particle stabilized by hydrophobic ligands. In this case, the pore-forming agent or agents will be chosen from the family of block copolymers and preferably from Pluronic® P123, F127, F108 and P104 triblock polymers.

The use of various types of particles in the walls, or both in the pores and in the walls, is particularly advantageous for applications in cascade or bifunctional catalysis. It is also possible for the metal of one of the types of particles, especially those located in the walls, to be magnetic, such as nickel or iron, in particular to facilitate separation.

If metal particles stabilized by hydrophobic ligands are also used, ligands comprising silane, stannous or thiol (SiHₓ, SnH_{y} or SH) groups may be used to stabilize the particles.

As examples of such hydrophobic ligands, mention may be made of alkylsilanes, arylsilanes and alkyltin compounds, such as n-butylsilane, n-octylsilane, phenylsilane, benzylsilane, tributyltin, trimethyltin, or an alkyl thiol such as butyl thiol.

The step of growing the material is followed by a treatment intended to eliminate the pore-forming agent and thus free the porosity of the material. The organic part of the ligands used is also eliminated. However, in the case of silane or stannous ligands, the Si or Sn atoms are retained: this is why the non-exchangeable ligands giving the particles their hydrophilic character are said to be partially eliminated. The same applies with the ligands containing a germanium atom, which is itself also retained during the treatment. Only the organic part of the ligands is eliminated. Such a treatment may be a calcination heat treatment. The final calcination temperature may be up to 500° C. and preferably around 350° C. A temperature rise profile of between 0.2° C. per minute and 3° C. per minute may be used and preferably a temperature rise profile between 0.5° C. per minute and 2° C. per minute may be employed.

It is also possible to eliminate the pore-forming agents and the ligands used, by degradation in an aqueous medium under UV irradiation, in the presence of a metal salt. The conditions of such a treatment are very mild:
the metal salt that may be used may be an organic or inorganic salt. As examples of organic salts, mention may be made of the family of carboxylates, within which are preferably citrates, oxalates and pyruvates. As examples of inorganic salts, mention may be made of sulfates, hypochlorates, chlorates, nitrates and carbonates. Various metal salts may be suitable, in particular titanium, vanadium, chromium, manganese, iron, cobalt or nickel salts may be used and, in particular, the abovementioned salts. Iron salts are particularly preferred. The metal used is in a form that can be oxidized or reduced under the UV treatment conditions and can then be reduced or oxidized respectively;
the treatment is carried out in aqueous medium. For example, the aqueous medium consists of water in which the metal salt used is dissolved or in suspension. The pH of the solution is adapted to the metal salt used and usually varies between 2 and 8, preferably between 3 and 6. The UV treatment may be carried out in any type of atmosphere, whether controlled or not. Preferably, the treatment is carried out in an atmosphere containing gaseous oxygen O₂, for example in air or a stream of oxygen;
the elimination of the organic part by degradation does not require a high-temperature heat treatment. For example, the UV treatment is carried out at a temperature between 0 and 100° C., preferably between 10 and 50° C., and preferentially between 20 and 30° C., especially at room temperature (about 25° C.). The treatment times are relatively short and vary, for example from 1 to 12 hours, preferably 3 to 8 hours;
the UV irradiation may cover a range of wavelengths corresponding to UV-A (400-315 nm), UV-B (315-280 nm) and UV-C (280-10 nm) or just to UV-A. To do this, a conventional UV lamp (400 nm-10 nm) may be used with or without a filter; and
the amount of metal salt corresponds to a catalytic amount with respect to the reaction of degrading the envisaged organic molecule. In order for the treatment time to be short, the envisaged (metal salt/molecule to be degraded) molar ratio may, for example, vary from 0.01 to 3, preferably from 0.1 to 1.5.

Such a degradation treatment under UV, just like the heat treatment, does not destroy the remaining inorganic part and neither damages the structure of the treated material nor even the metal particles.

It is clearly apparent that the process according to the invention makes it possible to produce structured porous materials, and especially mesostructured materials containing particles, in particular metal nanoparticles selectively localized within the walls of the porous framework.

The process according to the invention leads to the formation of particles uniformly distributed in the solid. These particles are completely accessible and reactive. Furthermore, because they are localized within the walls and are uniformly distributed, they are stable with respect to heat treatments, that is to say there is little or no sintering and no leaching. The process according to the invention is especially very advantageous for producing stable robust heterogeneous catalysts which are much more stable than those obtained by conventional methodologies such as the decomposition of metal salts or the impregnation of colloidal solutions on porous or nonporous supports. The process according to the invention is, inter alia, perfectly suited for: i) the synthesis of monometallic or multi-metallic materials, possibly containing several types of different particles; ii) the replacement of existing heterogeneous catalysts; and iii) the synthesis of novel monometallic or multi-metallic catalysts.

The materials obtained, in the context of the invention, contain small particles of monodispersed size. Now, the prior techniques have shown that, hitherto, it was very difficult to generate very small monodispersed particles on supports. In addition, in the context of the invention, it is possible to customize structured porous materials containing several types of particle without interaction between the particles, something which was very difficult using the prior techniques. Specifically, the process according to the invention makes it possible to produce stable heterogeneous catalyst materials containing one or more different metals, in the form of particles of metal 0. By having particles of different metals present, it is possible in particular to use the materials produced in bifunctional catalysis or for cascade reactions.

Consequently, the process according to the invention opens up new prospects in heterogeneous catalysis, enabling various multimetallic materials to be produced. The process and the materials according to the invention are therefore more particularly beneficial in the heterogeneous catalysis field. However, since the invention makes possible the customized localization of metal particles of various types within porous frameworks, it may be applicable in the gas purification field or the microelectronics field (for obtaining magnetic memories).

The examples below serve to illustrate the invention, but do not have any limiting character. The characterizations are carried out under the following conditions:

Elemental Analysis

The elemental analyses were carried out in the Laboratoire de Synthèse et Electrosynthèse Organométalliques, [Organometallic Synthesis and Electrosynthesis Laboratory], UMR 5188 CNRS, Dijon, France and at the Service Central d'Analyses [Central Analysis Service] of the CNRS at Vernaison, France.

Transmission Electron Microscopy (TEM)—

Microscopy Images of the Colloidal Solutions:

The microscopy images were obtained at the Centre Technologique des Microstructures [Microstructure Technology Center], UCBL, Villeurbanne,

France, using a Philips 120 CX transmission electron microscope. The acceleration voltage was 120 kV. A drop of the Pt colloidal suspension, prediluted in ethanol, was deposited on a copper grid coated with a carbon film.

Microscopy Images of Porous Materials Containing Nanoparticles of Metal (0):

1) The microscopy images were obtained at the Centre Technologique des Microstructures, UCBL, Villeurbanne, France, using a Philips 120 CX transmission electron microscope. The acceleration voltage was 120 kV. The grids were prepared either i) by depositing a drop of a suspension of the solid containing Pt nanoparticles diluted in ethanol, on a copper grid coated with a carbon film, or ii) by depositing a thin (50-70 nm) section, prepared by ultramicrotoming the solid, which was embedded beforehand in a resin, on a copper grid coated with a carbon film;

2) The high-resolution transmission electron microscopy images were produced at the Fritz-Haber Institute of the Max Planck Society of Berlin, Germany, using a Philips CM200 transmission electron microscope with an acceleration voltage of 200 kV.

Wide-Angle Powder X-ray Diffraction (WAXS):

The wide-angle X-ray diffraction measurements were made at the

CEMES in Toulouse on a SEIFERT XRD apparatus by scanning the following range of angles: 0°<2θ<65°. Extracted from the diffracted signal was a function called the “reduced intensity”, the Fourier transform of which then enabled the size of the platinum crystallites to be obtained, using a face centered cubic model).

Small-Angle Powder X-Ray Diffraction (XRD):

This analysis was carried out on a Bruker D8 Advance diffractometer machine (at 33 kV and 45 mA) using a copper anode (CuKα, λ=0.154 nm) at the Centre de Diffractomètrie H. Longchambon [H. Longchambon Diffractometry Center], UCBL, Lyons, France. The diffractograms were collected over a range of 2θ angles: [0.5°-10.0°] scanning at 0.1°/min. The interlattice distances d(hkl) were calculated using Bragg's Law (nλ=2dsinθ). The lattice cell parameter (a₀) for a mesoporous material of 2D hexagonal structure is given by the equation a₀=2d (100)/\sqrt{3}.

X-Ray Photoelectron Spectroscopy (XPS):

This analysis was carried out on a Kratos Analytical Axis Ultra DLD spectrometer using a monochromatic aluminum source with an energy of 20 eV and a coaxial charge neutralization system. The vacuum in the analysis chamber was better than 5×10⁻⁸ Pa. The spectra representing the 4f Pt, 2p Si and is 0 energy levels were measured at an angle normal to the plane of the surface. The high-resolution spectra were corrected for charge effects taking as reference value 284.5 eV for the peak of the 1s C level. The function used for peak deconvolution was a combination of Gaussian functions and Lorentzian functions with 40% Lorentzian (p), and after subtraction of the secondary electron background using the Shirley method. Nitrogen adsportion/desorption measurements:

The nitrogen adsorption/desorption measurements were carried out at −196° C. (77 K) using a Micromeritics ASAP 2020 machine. Before analysis, the specimens were degassed at 10⁻⁴ Paat 350° C. (623 K) for 2 hours. The distribution of pore diameters and the mean pore size (dₚ) were calculated using the BJH (Barrett-Joyner-Halenda) method. The specific surface areas (S_{BET}) were calculated using the BET (Brunauer-Emmett-Teller) equation.

The wall thicknesses (t_{w}) of the solids were calculated using the following formula: t_{w}=\sqrt{3} a₀/2−dₚ.

H₂ and O₂ Adsorption Measurements:

The H₂ adsorption measurements were carried out at 25° C. (298 K) in a conventional Pyrex system for adsorption volumetry. A vacuum of 10⁻⁴ Pa (10⁻⁶ mbar) was achieved using a mercury diffusion pump. The equilibrium pressures were measured with a Texas Instrument gauge (pressure range between 0-100 kPa (1000 mbar) with a precision of 0.01 kPa (0.1 mbar)). The specimen to be analyzed was placed in a Pyrex cell and degassed at 25° C. (298 K) and then at 300° C. (573 K) under reduced pressure for 3 hours before the chemisorption measures. The H₂/Pt ratios were calculated by extrapolating at zero pressure the adsorption isotherm obtained. The dispersion of the platinum nanoparticles, defined as the ratio of the number of surface platinum atoms to the total number of platinum atoms (Pt_{surface}/Pt) was deduced by considering a 1.0 H/Pt_{surface} and a 1.0 O/Pt_{surface} stoichiometry.

Gas Chromatography Phase:

The analyses were carried out on a Hewlett Packard 5890 Series II gas chromatography (GC) machine fitted with a flame ionization detector (FID) and a KCl/Al₂O₃ column (50 m×0.32 mm).

A. Synthesis of Silylated Ligands Giving the Particles a Hydrophilic Character:

I. Synthesis of 3-chloropropylsilane (C₃H₉ClSi):

3-Chloropropyltriethoxysilane (50 mmol) was introduced under argon drop by drop at 0° C. (273 K) into an ethereal solution of LiAlH₄ (50 mmol). The mixture was slowly raised to room temperature and then stirred for 12 hours. Next, the unreacted LiAlH₄ was destroyed using 10 ml of ethyl acetate. The suspension was then filtered. Next, the diethyl ether was evaporated under reduced pressure of 0.1 Pa (10⁻³ mbar). The residue was distilled under argon (T_{b}=95° C. (368 K)). The product was obtained in the form of a colorless liquid:
¹H NMR (300 MHz, CD₂Cl₂): 0.76; 1.74; 3.3; 3.54 ppm
¹³C NMR (75 MHz, CD₂Cl₂): 10.5; 12.2; 27.5 ppm
²⁹Si NMR (75 MHz, CD₂Cl₂): −58.7 ppm
Infrared: ν (Si—H): 2150 cm⁻¹, ν (C—H_{aliphatic}): 3000-2900 cm⁻¹.

II. Synthesis of N-(3-propylsilyl)imidazole (C₆H₁₂N₂Si):

N-(3-Propyltriethoxysilyl)imidazole (50 mmol) was introduced under argon drop by drop at 0° C. (273 K) into an ethereal solution (50 ml) of LiAlH₄ (50 mmol). The mixture was slowly raised to room temperature and then stirred for 12 hours. Next, the unreacted LiAlH₄ was destroyed using 10 ml of ethyl acetate. The suspension was then filtered. Next, the diethyl ether was evaporated under reduced pressure of 0.1 Pa (10⁻³ mbar). The product was obtained in the form of a colorless oil:
¹H NMR (300 MHz, CD₂Cl₂): 1.3-1.5; 2.55; 3.54; 7 ppm
²⁹Si NMR (75 MHz, CD₂Cl₂): −58.7 ppm

III. Synthesis of chlorobenzylsilane (C₇H₉ClSi):

The chlorobenzyltriethoxysilane (50 mmol) was introduced under argon drop by drop at 0° C. (273 K) into an ethereal solution (50 ml) of LiAlH₄ (50 mmol). The mixture was slowly raised to room temperature and then stirred for 12 hours. Next, the unreacted LiAlH₄ was destroyed using 10 ml of ethyl acetate. The suspension was then filtered. Next, the diethyl ether was evaporated under reduced pressure of 0.1 Pa (10⁻³ mbar). The product was obtained in the form of a colorless liquid:
¹H NMR (300 MHz, CD₂Cl₇): 0.76; 1.74; 3.3; 3.54 ppm
¹³C NMR (75 MHz, CD₂Cl₂): 10.5; 12.2; 27.5 ppm
Infrared: ν (Si—H): 2140cm⁻¹, ν (C—H_{aliphatic and aromatic}): 3100-2900 cm⁻¹; 700-900 cm⁻¹

IV. Chlorodimethylsilane (C₂H₇ClSi):

Commercial product (ABCR), used as such.

B. Synthesis of Colloidal Suspensions of Hydrophilic Nanoparticles:

I. Example of a Hydrophilic Pt Colloidal Solution Stabilized by 3-chloropropylsilane:

100 mg (0.15 mmol) of Pt (dba)₂ (where dba=dibenzylideneacetone) were placed in a glass reactor and subjected to reduced pressure for 30 minutes at room temperature. 90 ml of THF (tetrahydrofuran) were then added. 10 ml of THF containing 25 mg of 3-chloropropylsilane (0.15 mmol) were added at room temperature. The solution obtained was pressurized at 300 kPa (3 bar) of hydrogen and stirred for 12 hours.

FIG. 2 shows the histogram of the size of the particles obtained.

A hydrophilicity test was carried out by placing the particle suspension obtained in a vessel containing a water/heptane two-phase mixture, the water lying beneath the heptane in the vessel: the metal particles went into the aqueous phase and not into the heptane phase, thereby demonstrating their hydrophilic character.

II. Example of a Hydrophilic Ru Colloidal Solution Stabilized by 3-chloropropylsilane:

100 mg (0.29 mmol) of Ru (COD)(COT) (where COD=cyclooctadiene and COT=cyclooctatetraene) were placed in a glass reactor and subjected to reduced pressure for 30 minutes at room temperature. 90 ml of THF were then added. 10 ml of THF containing 40 mg of 3-chloropropylsilane (0.29 mmol) were added at room temperature. The solution obtained was pressurized at 300 kPa (3 bars) of hydrogen and stirred for 12 hours.

FIG. 3 shows the histogram of the size of the particles obtained.

A hydrophilicity test was carried out as previously and demonstrated the hydrophilic character of the particles obtained.

III. Example of a Hydrophilic Pt Colloidal Solution Stabilized by Chlorobenzylsilane:

100 mg (0.15 mmol) of Pt (dba)₂ were placed in a glass reactor and subjected to reduced pressure for 30 minutes at room temperature. 90 ml of THF were then added. 10 ml of THF containing 23 mg (0.15 mmol) of chlorobenzylsilane were added at room temperature. The solution obtained was pressurized at 300 kPa (3 bar) of hydrogen and stirred overnight.

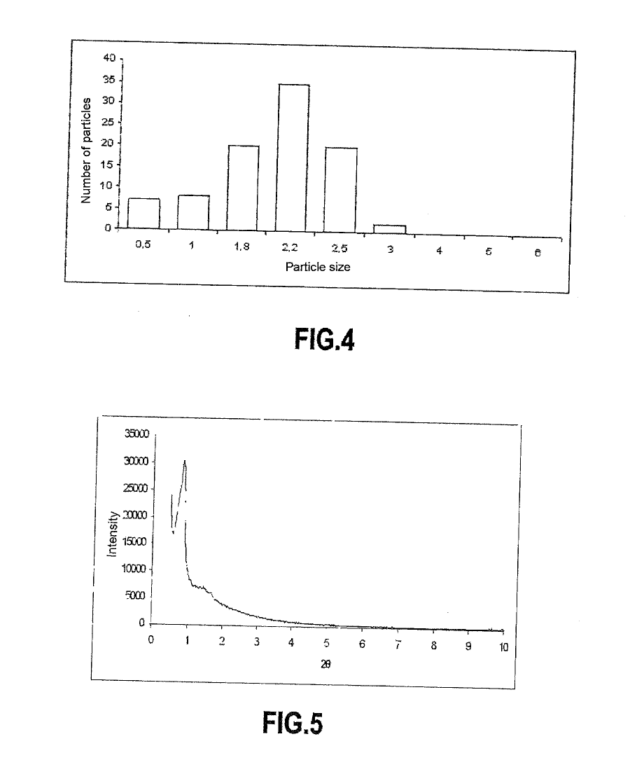

FIG. 4 shows the histogram of the size of the particles obtained.

A hydrophilicity test was carried out as previously and demonstrated the hydrophilic character of the particles obtained.

IV. Example of a Hydrophilic Pt Colloidal Solution Stabilized by Chlorodimethylsilane:

100 mg (0.15 mmol) of Pt (dba)₂ were placed in a glass reactor and subjected to reduced pressure for 30 minutes at room temperature. 90 ml of THF were then added. 10 ml of THF containing 15 mg (0.15 mmol) of chlorodimethylsilane were added at room temperature. The solution obtained was pressurized at 300 kPa (3 bar) of hydrogen and stirred overnight.

A hydrophilicity test was carried out as previously and demonstrated the hydrophilic character of the particles obtained.

V. Example of a Hydrophobic Pt Colloidal Solution Stabilized by Octylsilane:

100 mg (0.15 mmol) of Pt (dba)₂ were placed in a glass reactor and subjected to reduced pressure for 30 minutes at room temperature. 90 ml of THF were then added. 10 ml of THF containing 20 mg (0.15 mmol) of octylsilane were added at room temperature. The solution obtained was pressurized at 300 kPa (3 bar) of hydrogen and stirred overnight.

A hydrophilicity test was carried out as previously and demonstrated the hydrophobic character of the particles obtained.

C. Materials Containing Metal Nanoparticles Stabilized by Silane Ligands in the Walls:

I. Silica Containing Pt Nanoparticles Stabilized by 3-chloropropylsilane Ligands in the Walls:

1. Synthesis:

0.5 g (86 μmol) of the structuring surfactant P123 (Pluronic 123 (Aldrich, 98%): H—(O—CH₂—CH₂—)₂₀—(O—CH₂(CH₃)—CH₂)₇₀—(O—CH₂—CH₂)₂₀—OH) was added to 50 ml of distilled water containing 20 mg of NaF in an Erlenmeyer flask, with vigorous stirring. After a homogeneous solution was obtained, 20 ml of a colloidal solution of hydrophilic platinum nanoparticles (24 μmol) prepared previously as in section B-I in a solvent (THF) were added. The mixture was vigorously stirred for 2 hours. The THF was then evaporated under reduced pressure. 5g (24 mmol) of TEOS (tetraethyl orthosilicate) were mixed in a second Erlenmeyer flask with an aqueous HCl solution (final pH=1.5) for 3 hours. The two reaction mixtures were heated to 35° C. and then brought into contact with each other. The final reaction mixture was stirred for 24 hours at 35° C. The suspension was then filtered and the solid obtained was washed twice with 20 ml of water, ethanol, acetone and ether.

2. Characterization Before Treatment:

FIG. 5 shows the small-angle X-ray powder diffractogram of the solid obtained and demonstrates the structuration of the material obtained.

FIGS. 6A and 6B are transmission electron microscope images showing the 2D hexagonal structure of the porous channels and the presence of Pt particles within the material obtained.

FIG. 7 shows the WAXS spectrum of the material containing Pt particles in the walls before elimination of the surfactant and the carbon chains of the stabilizing ligands (MB194 curve) and the simulated spectrum of a 2 nm Pt crystallite by modeling it with atomic stacking of the face centered cubic type (fcc Pt curve). The size of the particles before heat treatment, given by WAXS, was 2 nm and the fcc Pt curve is a simulation corresponding to such particles. It is therefore apparent that, within the material, the particles have remained small in size, being comparable to the size that they had in colloidal suspension.

3. Characterization After Treatment:

a) Treatment by Calcination at 350° C. (623 K):

The calcination consisted in introducing 1 g of non-extracted material placed in a reactor under a stream of dry air. The reactor was then heated to 623 K with a temperature rise of 2 K per minute.

Characterization of the Material After Treatment:

Structural Characteristics of the Material:

FIG. 8 gives the small-angle X-ray powder diffractogram (a=115 Å) of the material obtained. This diffractogram shows a diffraction peak that can be attributed to diffraction by the families of (100) lattice planes, and two harmonics corresponding to diffraction by the (110) and (200) planes. The material therefore possesses a porous structure in the form of a 2D hexagonal lattice. This is confirmed by transmission electron microscopy.

FIG. 9 shows, in bold, the experimental Fourier transforms (before calcination: top curve superimposed on the model; and after calcination: bottom curve) and as the dotted curve, the theoretical models of a 2 nm Pt crystallite in a face centered cubic (fcc) crystallographic lattice. Here again, it appears that, after treatment, the particles within the material have remained small in size, having a size comparable to that which they had in colloidal suspension.

Textural Characteristics of the Material:

S_{BET}: 958±20 m²/g

Pore volume: 1.0±0.1 m³/g

Pore diameter: 6±1 nm

Wall thickness: 8±1 nm

Structural Characteristics of the Material and Presence of Nanoparticles:

FIG. 10 shows various transmission electron microscope images after calcination of the material, demonstrating the presence of metal particles within the walls of the framework of the material.

Catalytic Performance:

Hydrogenation of Propene in a Continuous-Flow Reactor

The catalyst (7 mg, (0.107 μmol) of Pt) diluted in silicon carbide (50 mg) was placed in a glass reactor. An inert gas (helium) was passed through the reactor for one hour. Next, the Pt was reduced in H₂ for 3 h at 573 K. Finally, the reactor was brought into contact with a propene/H₂/He reaction mixture (20/16/1.09 cm³/min). The pressure was 100 kPa (1 bar). The reaction was monitored by gas chromatography.

The results are given in FIG. 11, which shows the degree of conversion of propene as a function of time.

Experimental Performance Obtained:

Turnover frequency (TOF) (at 10 minutes)=180 min⁻¹

b) After Iron/UV Treatment:

Protocol: Extraction of the material containing platinum particles stabilized by 3-chloropropylsilane ligands by the iron/UV treatment.

100 mg of the material were suspended in a 200 ml beaker containing 50 ml of an aqueous sulfuric acid solution at pH=3. Next, 10 mg (0.36 mmol) of FeSO₄ were added. The mixture was vigorously stirred at room temperature in air, under UV irradiation, with a power of about 5 watts/m² (125 W Philips HPK mercury vapor lamp) for 5 hours. The solid was filtered and then washed with 20 ml of distilled water and acetone. It was then dried under reduced pressure of 10⁻³ Pa (10⁻⁵ mbar) at 135° C. for 12 hours.

FIG. 12 shows the nitrogen adsorption/desorption isotherm at −196° C. (77 K) of the material containing the platinum particles obtained after treatment. The material containing nanoparticles of metal 0 in the walls has an isotherm characteristic of mesoporous solids (type IV isotherm) and whose distribution of the pore population is narrow.

FIG. 13 shows the XPS spectrum of the material containing Pt particles in the walls of the material:

Binding energies: (eV)

2p Si internal reference=103.6 eV

| | 4f_{7/2} Pt | | 2p Si |
|---|---|---|---|
| Material containing hydrophilic | 71.1 | (75%) | 103.6 |
| particles in the walls after calcination | 72.6 | (25%) | |
| Bare Pt particles supported on Al₂O₃ | 71.5 | (100%) | 103.6 |

Deconvolution of the 4f Pt Curve:

a 4f_{7/2} Pt-4f_{5/2} Pt doublet (71.0 eV-74.25 eV) assigned to Pt—Pt

a 4f₇₁₂ Pt-4f₅₁₂ Pt doublet (72.5 eV-75.75 eV) assigned to Pt—Si

The Pt—Pt° represent about 75% of total amount of Pt atoms. The presence of Si—Pt_{surface} bonds (25%) is detected and even after calcination at 623 K no oxidized Pt was detected.

The presence of silicon atoms bonded to the surface Pt atoms before and after heat treatment confirms the non-exchangeable character of the surface ligands bonded to the particles. Furthermore, the absence of platinum oxide clearly confirms the purely metallic (metal 0) nature of the particles incorporated into the material.

II. Silica Containing Ru Nanoparticles Stabilized by 3-chloropropylsilane Ligands in the Walls:

1. Synthesis:

0.5 g (86 μmol) of the structuring surfactant P123 was added to 50 ml of distilled water containing 20 mg of NaF in a 150 ml Erlenmeyer flask, with vigorous stirring. After a homogeneous solution was obtained, 20 ml of a colloidal solution of hydrophilic Ru nanoparticles (24 μmol) prepared beforehand as in section B-I in a solvent (THF) were added. The mixture was vigorously stirred for 2 hours. The THF was then evaporated under reduced pressure. 5g (24 mmol) of TEOS were added in a second Erlenmeyer flask to an aqueous HCl solution (final pH=1.5) and hydrolyzed for 3 hours. The two reaction mixtures were heated to 35° C. and then brought into contact with each other, the whole being finally stirred for 24 hours at 35° C. The gray-beige solid obtained was filtered and then washed twice in 20 ml of water, ethanol, acetone and ether.

2. Characterization Before Treatment:

FIG. 14 shows a transmission electron microscope image, clearly demonstrating the 2D hexagonal structuration of the material.

3. Characterization After Calcination at 350° C. (623 K) (in Accordance with Section C.I.3.a):

The material containing ruthenium 0 nanoparticles in the walls have an isotherm characteristic of a mesoporous solid (type IV isotherm) and a narrow distribution of the mesoporous population.

Texture of the material:

S_{BET}: 960±20 m²/g;

Sₘₑₛₒₚₒᵣₑ: 630±20 m²/g;

S_{micropore}: 340±20 m ²/g;

Pore volume: 1.2±0.1 m³/g;

Pore diameter: 6±1 nm;

Wall thickness: 8±1 nm

III. Silica Containing Pt Nanoparticles Stabilized by Chlorobenzylsilane Ligands in the Walls:

1. Synthesis:

0.5 g (86 μmol) of the structuring surfactant P123 was added to 50 ml of distilled water containing 20 mg of NaF in a 150 ml Erlenmeyer flask, with vigorous stirring. After a homogeneous solution was obtained, 20 ml of a colloidal solution of hydrophilic platinum nanoparticles (24 μmol) prepared beforehand as in section B-III in a solvent (THF) were added. The mixture was vigorously stirred for 2 hours. The THF was then completely evaporated under reduced pressure. 5 g (24 mmol) of TEOS were added in a second Erlenmeyer flask to an aqueous HCl solution (final pH=1.5) and hydrolyzed for 3 hours. The two reaction mixtures were heated to 35° C. and then brought into contact with each other, the whole being finally stirred for 24 hours at 35° C. The gray-beige solid obtained was filtered and then washed twice in 20 ml of water, ethanol, acetone and ether.

2. Characterization Before Treatment:

FIG. 15 shows a transmission electron microscope image, clearly demonstrating the 2D hexagonal structuration of the material and the presence of particles in the walls.

IV. Silica Containing Pt Nanoparticles Stabilized by Chloropropylsilane Ligands in the Walls and Pt Particles Stabilized by Octylsilane Ligands in the Pores: 1. Synthesis:

0.5 g (86 μmol) of the structuring surfactant P123 was added to 50 ml of distilled water containing 20 mg of NaF in a 150 ml Erlenmeyer flask, with vigorous stirring. After a homogeneous solution was obtained, 20 ml of a colloidal solution of hydrophilic platinum nanoparticles (24 μmol) prepared beforehand as in section B-I in a solvent (THF) were added. Next, 30 ml of a colloidal solution of hydrophobic platinum nanoparticles (0.045 mmol) prepared as in section B-V in a solvent (THF) were also added. The mixture was vigorously stirred for 2 hours. The THF was then completely evaporated under reduced pressure. 5 g (24 mmol) of TEOS were mixed in a second Erlenmeyer flask with an aqueous HCl solution (final pH=1.5) and hydrolyzed for 3 hours. The two reaction mixtures were heated to 35° C. and then brought into contact with each other, the solution obtained being stirred for 24 hours at 35° C. The suspension obtained was then filtered and the solid obtained washed twice in 20 ml of water, ethanol, acetone and ether.

2. Characterization After Calcination at 350° C. (623 K) (in Accordance with Section C.I.3a)

From the nitrogen adsorption/desorption measurements, the material has the following characteristics, namely porosity of the mesoporous/microporous type with a large pore volume and a mesopore population centered on 6 nm and a wall thickness of 7 nm:

S_{BET}: 870±20 m²/g;

Sₘₑₛₒₚₒᵣₑ: 540±20 m²/g;

S_{micropore}: 330±20 m²/g;

Pore volume: 1.0±0.1 m³/g;

Pore diameter: 6±1 nm;

Wall thickness: 7±1 nm

V. Mixed SiO₂/TiO₂ Oxide Containing Pt Nanoparticles Stabilized by 3-chloropropylsilane Ligands in the Walls:

0.5 g (86 μmol) of the structuring surfactant P123 was added in a 150 ml Erlenmeyer flask to 50 ml of distilled water containing 20 mg of NaF, with vigorous stirring. After a homogeneous solution was obtained, 20 ml of a colloidal solution of hydrophilic platinum nanoparticles (24 μmol) in a solvent (THF) were added. The mixture was vigorously stirred for 2 hours. The THF was then completely evaporated under vacuum (10⁻³ mbar). 4.86 g (23 mmol) of tetramethoxysilane were mixed in a second Erlenmeyer flask with an aqueous HCl solution (final pH=1.5) for 2 hours. Next, 20 mg (0.6 mmol) of titanium tetraisopropoxysilane were added, the whole being stirred for 20 minutes. Finally, the two reaction mixtures were heated to 35° C. and then brought into contact with each other and stirred at this temperature for 24 hours. The solution was then filtered and the solid obtained was washed twice in 20 ml of water, ethanol, acetone and ether.

2. Characterization After Calcination at 350° C. (623 K)

From the nitrogen adsorption/desorption measurements the material had the following characteristics:

S_{BET}: 500±20 m²/g;

Sₘₑₛₒₚₒᵣₑ: 360±20 m²/g;

S_{micropore}: 140±20 m²/g;

Pore volume: 0.6±0.1 m³/g;

Pore diameter: 6±1 nm

D. Comparison with Other Materials Containing Particles in the Pores or in the Surface:

Silica Containing Pt Nanoparticles Stabilized by Octylsilane Ligands in the Pores:

1.7 g (0.29 mmol) of the surfactant P123 were added in a 150 ml

Erlenmeyer flask to a solution of hydrochloric acid at pH=1.5 (63 ml) with vigorous stirring. After a homogeneous solution was obtained, 30 ml of a colloidal solution of platinum nanoparticles (0.045 mmol) in tetrahydrofuran (Pelzer, K.; et al., Chem. Mater. 16, 4937-4941, 2004), were added. The mixture was vigorously stirred for 2 hours. Next, 3.53 g (17 mmol) of TEOS were rapidly added and the mixture left stirring for 3 h. The reaction mixture was then heated to 45° C. and then 25 mg of NaF were rapidly added. Finally, the mixture was stirred for 48 hours at 45° C. The white solid obtained was filtered and then washed twice with 20 ml of water, ethanol, acetone and ether.

The material obtained was treated by calcination at 350° C.

The small-angle X-ray powder diffractograms, before and after calcination, are identical, and show a peak corresponding to 2θ=0.9°.

The FIGS. 16a) and b) show the type IV nitrogen adsorption/desorption isotherm at −196° C. (77 K) of the material obtained and the pore distribution, respectively. From the nitrogen adsorption/desorption measurements, the material had the following characteristics, namely a predominantly mesoporous porosity with a pore population centered on 8.5 nm and a wall thickness of 3 nm:

S_{BET}: 1050±20 m²/g;

Sₘₑₛₒₚₒᵣₑ: 840±20 m²/g;

S_{micropore}: 230±20 m²/g;

Pore volume: 1.5±0.1 m³/g;

Pore diameter: 8.5±1 nm;

Wall thickness: 3±1 nm

The WAXS study shows that the particle sizes goes from 2 to 4 nm for the material containing Pt in the pores, whereas the particles remain at 2 nm for the material containing particles in the walls.

3. Comparison of the Catalytic Activities

Continuous-Flow Hydrogenation of Propene

7 mg of catalyst (0.3 wt % of Pt (0.107 μmol)) were placed in a continuous-flow fixed-bed reactor. The reactor was purged with helium for 1 hour. The catalyst was placed in a stream of H₂ for 3 hours at 573 K before being connected to a propene/H₂/He mixture at a pressure of 100 kPa (1 bar). The reaction was monitored by gas chromatography.

FIG. 17 compares the degrees of conversion obtained by propene hydrogenation in a dynamic reactor with the material according to the invention, as described in section C.3.1 and that obtained previously with Pt particles in the pores.

Experimental Performance Obtained:

Turnover frequency (TOF) (at 10 minutes) for the material containing Pt particles in the pores: 55 min⁻¹

Turnover frequency (TOF) (at 10 minutes) for the material containing Pt particles in the walls: 180 min⁻¹

In conclusion, the catalytic activities obtained are comparable, even with a slightly improved activity in the case of the materials according to the invention.

Therefore, the particles localized in the walls remain accessible, and therefore active and reactive.

Silica Containing Pt Nanoparticles Stabilized by Octylsilane Ligands Prepared According to Section B.V in the Pores and Obtained by Impregnation of a Colloidal Solution on a Mesostructured Support of the SBA-15 Type:

Synthesis (Zhao, D., et al, Science 1998, 279, 548-552):

1st step (synthesis of the mesostructured support):

1.7 g (0.29 mmol) of P123 were added in an Erlenmeyer flask to a hydrochloric acid solution at pH=1.5 (63 ml) with vigorous stirring. After a homogeneous solution was obtained, TEOS was added and the reaction mixture left stirring for 3 hours. The solution was then heated to 45° C. and then 25 mg of NaF were rapidly added. Finally, the mixture was stirred for 48 hours at 45° C. The white solid obtained was filtered and then washed twice with 20 ml of water, ethanol, acetone and ether.

FIG. 18 shows the type IV nitrogen adsorption/desorption isotherm at −196° C. (77 K) of the material obtained and the pore distribution. From the nitrogen adsorption/desorption measurements, the material had the following characteristics:

S_{BET}=1000 m²/g;

Vₚ=1.5 cm³/g;

Dₚ (adsorption): 9 nm

2nd step:

A colloidal solution of Pt stabilized by octylsilane ligands in THF was brought into contact with the support suspended beforehand in a few milliliters of THF. The suspension obtained was left stirring for 24 hours and then the THF was evaporated under reduced pressure of 0.1 Pa (10⁻³ mbar). 2 g of a gray powder were obtained.

Characterization of the Material After Calcination at 350° C. (623 K)

FIG. 19 shows a transmission electron microscope image of the impregnated material obtained after calcination.

It appears that there is substantial sintering of the particles within the mesostructured support, which explains the zero catalytic activity of the material, after treatment, found in the propene hydrogenation reaction.

Pt Nanoparticles Deposited on Alumina (Monometallic Industrial Catalyst Laden with Pt (0.32 wt %) on 200 m²/g Gamma-Alumina Supplied by Axens Group Technologies) 1. Characteristics:

Particle size: 1 nm (80 to 90% dispersion)

% Pt in the material: 0.3 wt % 2. Comparison of the Catalytic Activities

FIG. 20 compares the degrees of conversion obtained for the hydrogenation of propene with the reference catalyst and the material according to the invention, as described in section C.3.1

Experimental performance:

TOF (at 10 minutes) of the reference material: 60 min⁻¹

TOF (at 10 minutes) of the material containing Pt particles in the walls: 180 min⁻¹.

It therefore appears that the activities are comparable. These results prove that the Pt particles remain active and reactive despite them being localized within the walls of a porous framework and they have an activity comparable to bare Pt particles on the surface of an alumina support.

Styrene Hydrogenation Catalysis at Room Temperature in a Closed Reactor:

Protocol:

The catalyst investigated (0.96 μmol of Pt_{surface}), styrene (8862 μmol; 9200 eq.) and the solvent (50 ml of heptane) were placed in a 100 ml batch reactor under argon. The reaction mixture was stirred and then H₂ added at 3500 kPa (35 bar). During the reaction, small amounts of the reaction mixture were taken off and analyzed by gas chromatography so as to monitor the kinetics of the reaction.

Results:

FIG. 21 shows the amounts of styrene and ethylbenzene as a function of time, obtained during the hydrogenation of styrene with the material containing Pt particles in the walls after calcination, as described in section C.3.1 (R=9200 for 40% dispersion).

FIG. 22 shows the amounts of styrene and ethylbenzene as a function of time during the hydrogenation of styrene with the Pt reference catalyst on alumina (90% dispersion, Pt particles of about 1 nm, R=5000).

The activities obtained are also comparable:

TOF (at 10 minutes) of the material with Pt in the walls: 160 min⁻¹

TOF (at 10 minutes) of the reference material: 80 min⁻¹

Consequently, even in the case of catalytic reactions carried out on larger molecules, such as styrene, the Pt particles localized in the walls of a porous framework remain accessible and therefore active and reactive.

E. Behavior of Colloidal Solutions of Hydrophilic Particles Stabilized by Exchangeable Bonds in the Presence of a Pore-Forming Agent and Synthesis of an Organized Material Containing Nanoparticles Stabilized by Exchangeable Hydrophilic Ligands

It was observed that the use of exchangeable ligands for stabilizing the nanoparticles resulted in surface exchanges with molecules present during the sol-gel process (pore-forming agent, alcohol resulting from the hydrolysis of the alkoxysilane precursors) and that, consequently, the incorporation of these nanoparticles into the silica framework was disturbed. To confirm this, Pt nanoparticles were prepared using a hydrophilic exchangeable ligand: 1,8-octanediol. After having confirmed the hydrophilic character of these Pt particles by the test described in section B.I., and verifying their small size by TEM (circa 2.4 nm), one aliquot (5 ml) of this solution was removed and the solvent was evaporated under reduced pressure. The residue containing the particles was then dissolved in deuterated benzene (0.4 ml) and the solution thus obtained was placed in an NMR tube. 0.3 equivalent of cetyl ammonium bromide was then added and the exchange reaction monitored using ¹H NMR: the signal corresponding to the ammonium group progressively disappeared, while the signal corresponding to the hydroxyl group increased (up to twice the magnitude). This therefore confirmed the exchange reaction between an ammonium ligand (which also acts as pore-forming agent) and the hydrophilic ligand initially stabilizing the nanoparticles.

Furthermore, to further confirm this exchange during the sol-gel process, the material as described in section C.I.1 was synthesized from the above colloidal solution. From the microscope images shown in FIG. 23, the material obtained was structured. However, the nanoparticles were not incorporated into the walls of the silica structure, rather they were agglomerated and rejected from the structure. Thus, as expected, a highly heterogeneous material was obtained with Pt nanoparticles which are not all uniformly distributed within the matrix and which, as a consequence, become sintered during the first heat treatment.

1- A process for producing a structured porous material comprising a structured inorganic framework made up of metal-oxide-based walls in which particles of metal 0 are incorporated, said material being characterized by the presence of at least one diffraction peak in a small-angle X-ray powder diffractogram associated with a spatial repeat period of the structured system that corresponds to the periodicity of the pores within the material, which process, comprises the following steps:
a) formation of a suspension of hydrophilic particles of metal 0 stabilized by non-exchangeable ligands that give the particles their hydrophilic character, in which the metal core of the metal particles (excluding ligands) is essentially spherical and at least, for 50% of the particle population, the metal core has a mean diameter of 1 to 10 nm, the metal particles being monodispersed, that is to say they have a very narrow size distribution around a mean value, so that 50% of the particles have their size corresponding to the mean size±03 nm;
b) growth of the inorganic framework from an inorganic precursor around the particles of metal 0 stabilized by the non-exchangeable ligands that give the particles their hydrophilic character, in the presence of a pore-forming agent, the total size of the hydrophilic particles stabilized by the non-exchangeable ligands that give them their hydrophilic character being less than or equal to the thickness of the walls of the inorganic framework obtained; and
c) elimination of the pore-forming agent and at least partially of the non-exchangeable ligands that give the particles their hydrophilic character.

2- The process as claimed in claim 1, characterized in that the non-exchangeable ligands are silanes, stannic derivatives or stannous derivatives in which the silicon or tin atom acts as the point where the ligand is anchored onto the metal particle.

3- The process as claimed in claim 1, characterized in that the non-exchangeable ligands comprise a germanium atom that acts as the point where the ligand is anchored onto the metal particle.

4- The process as claimed in claim 1, characterized in that the thickness of the walls is greater than 3 nm and preferably lies in the range from 5 to 15 nm.

5- The process as claimed in claim 1, characterized in that the structuration of the porous material is of the vermicular, lamellar, hexagonal (1D or 2D) or cubic type.

6- The process as claimed in claim 1, characterized in that the non-exchangeable ligands comprise polar or polarizable groups, especially chosen from halogen atoms, such as chlorine, or amine, ammonium, phosphonate, phosphonium, hydroxide, thiol, sulfonate, nitrate, carbonate and alcohol groups, which give the particles their hydrophilic character.

7- The process as claimed in claim 1, characterized in that the non-exchangeable ligands are chosen from 3-chloropropylsilane, N-(3-silylpropyl)imidazole, chlorobenzylsilane, chlorodimethylsilane, N-(3-silylpropyl)alkylimidazolium salts or N-(3-silylpropyl)arylimidazolium salts, N-(benzylsilyl)imidazole, N-(benzylsilyl)alkylimidazolium salts or N-(benzylsilyl)arylimidazolium salts, and also N-(benzylsilyl)trialkylammonium salts or dibutyl-4,7,10-trioxaundecylstannane.

8- The process as claimed in claim 1, characterized in that the inorganic framework consists of silica, a silica/titanium oxide mixture or a silica/alumina mixture.

9- The process as claimed in claim 1, characterized in that the metal particles are platinum, ruthenium, gold, nickel, cobalt, iron, silver, palladium or rhodium particles.

10- The process as claimed in claim 1, characterized in that the metal framework is grown by a sol-gel process.

11- The process as claimed in claim 1, characterized in that the inorganic precursor is a metal or metalloid alkoxide or hydroxide, preferably a titanium or aluminum silicate, tetraalkoxysilane, or tetraalkoxide.

12- The process as claimed in claim 1, characterized in that the framework is grown in an aqueous medium or an aqueous medium mixed with at least one cosolvent chosen from alcohols, preferably linear alcohols such as butanol, ethers such as THF, and dimethylformamide.

13- The process as claimed in claim 1, characterized in that the framework is grown at a temperature ranging from 0° C. to 100° C., preferably from 20° C. to 65° C.

14- The process as claimed in claim 1, characterized in that the framework is grown with a molar (metal of the inorganic precursor/pore-forming agent) ratio of 30-300.

15- The process as claimed in claim 1, characterized in that the framework is grown with a (metal of the particles/metal of the inorganic precursor) weight ratio of less than 10%, preferably from 0.001% to 5% and preferentially from 0.005 to 5%.

16- The process as claimed in claim 1, characterized in that the framework is grown in a medium having a pH of 0 to 10 and preferably 0 to 4.

17- The process as claimed in claim 1, characterized in that the framework is grown in the presence of a hydrolysis-polycondensation catalyst of the acid, base or nucleophilic type and preferably such as HO (acid type), NH₃, KOH, or NaOH (base type) or NaF or TBAF (nucleophilic type).

18- The process as claimed in claim 1, characterized in that the pore-forming agent is chosen from:
anionic templates, such as sodium dodecyl sulfate;
cationic templates, such as ammonium salts, imidazolium salts, pyridinium salts;
nonionic templates, and especially amines;
alkyl polyethylene or alkylaryl polyethylene oxides;
polysorbate templates;
amphiphilic block copolymers; and
conventional polymers of the PE, PP, PMMA and polystyrene type.

19- The process as claimed in claim 1, characterized in that the pore-forming agent is eliminated by heat treatment or by degradation in an aqueous medium under UV irradiation, or in the presence of a metal salt.

20- The process as claimed in claim 1, characterized in that, prior to growth of the framework, a colloidal suspension of particles of metal 0 rendered hydrophilic and stabilized by non-exchangeable ligands is produced, to which a core-forming agent, preferably in a water/THF mixture, is added.

21- A structured porous material that can be obtained as claimed in claim 1, comprising a structured framework made up of metal-oxide-based walls in which particles of metal 0 are incorporated.

22- The material as claimed in claim 21, characterized in that it has a specific surface area of 20 to 1200 m²/g and preferably 300 to 1100 m²/g in the case of a framework made up predominantly of silica.

23- The material as claimed in claim 21 characterized in that the size of the walls is greater than 3 nm and, preferably in the range from 5 to 15 nm.

24- The material as claimed in claim 21, characterized in that inorganic framework is made up of at least one metal or an oxide of a metal of groups 3 to 11, or of at least one oxide of a metalloid of groups 2 and 12 to 14, or of a mixture of various metals or metal oxides or of a mixture of these oxides, especially those chosen form silicon, aluminum, titanium, tin, tantalum or zirconium.

25- The material as claimed in claim 21 characterized in that the inorganic framework is made up of silica or a mixed, silica/titanium oxide or silica/alumina, oxide (especially aluminosilicates).

26- The material as claimed in claim 21 characterized in that it has a microporosity, a mesoporosity or a mixed microporosity/mesoporosity.
